(19) United States
(12) Patent Application Publication
(10) Pub. No.: US 2006/0232547 A1
(43) Pub. Date: Oct. 19, 2006

(54) Electrophoretic display panel with reduced power consumption

(75) Inventors: Mark Thomas Johnson, Eindhoven (NL); Guofu Zhou, Eindhoven (NL); Johannes Petrus Van De Kamer, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/564,381

(22) PCT Filed: Jul. 7, 2004
(86) PCT No.: PCT/IB04/51151

§ 371 Date: Jan. 12, 2006

(30) Foreign Application Priority Data
Jul. 15, 2003 (EP) 03102160.3

(51) Int. Cl. G09G 3/34

(52) U.S. Cl. 345/107

(57) ABSTRACT

This invention relates to an electrophoretic display panel (1), for displaying an image corresponding to image information, comprising a plurality of pixels (4), each containing an amount of an electrophoretic material, an electrode arrangement (8, 9) associated with each pixel (4) for receiving a potential difference as defined by an update drive waveform (12); and pixel drive means (10), for controlling said update drive waveform (12) of each pixel (4). The display panel further comprises an image information analyser (11) arranged to analyse the image information for a current image frame (13) to be displayed by the display panel with the image information of a previous image frame (14), the image information analyser (11) being arranged to control said pixel drive means (10) so as to, at least in a portion of the display, only update a subgroup of pixels (4) which, as analysed by the image information analyser (11) is arranged to display a greyscale in the current image frame (13) which differs from the greyscale displayed in the previous image frame (14).

This invention relates to an electrophoretic display panel, for displaying an image corresponding to image information, comprising a plurality of pixels, each containing an amount of an electrophoretic material, an electrode arrangement associated with each pixel for receiving a potential difference as defined by an update drive waveform and pixel drive means, for controlling said update drive waveform of each pixel.

Electrophoretic display devices are based on motion of charged, usually, coloured particles under the influence of an electric field. Such displays are suitable in paper-like display functions, such as electronic newspapers and electronic diaries. One type of electrophoretic display device comprises a fluid, in which a plurality of charged particles are dispersed. The positions of the charged particles within the fluid are controlled by the application of an electric field over the fluid. This is usually made by sandwiching a layer of the fluid/particle material between a first and a second electrode. In a basic embodiment, coloured particles, such as black particles are dispersed in a white fluid (hereinafter referred to as one-particle type). Alternatively, at least two different types of coloured particles, having different charges, for example black negatively charged particles and white positively charged particles, are dispersed in a clear fluid (hereinafter referred to as two-particle type).

An example of an electrophoretic display device of the type mentioned above is described in the Patent application WO 02/073304. In the described electrophoretic display panel, each picture element or pixel has, during the display of the picture, an appearance determined by the position of the particles in the fluid. Hence, greyscales in such a display are generally created by applying a sequence of voltage pulses, referred to as an update drive waveform over each picture element for a specific time period. A large number of greyscales are desired for displaying a picture which looks natural. For this purpose, a variety of different update drive waveforms has been developed in order to generate different greyscales. A problem with this kind of display is however that the position of the particles do not only depend on the applied potential difference or waveform, but also on the history of the previously applied potential difference of each picture element. Most of the developed update drive waveforms require that the greyscale level of each picture element in an image to be displayed is compared to its state in the present image, and based upon this comparison, one of a series of waveforms is selected. Hence, in an example with four grey levels, it is necessary to store sixteen different waveforms, i.e. one wave form for each transition from any one to any one of the four grey levels.

In order to update an image displayed on the display device, all pixels of the display are driven by pixel voltages, for example −15 V, +15 V or 0 V, for the duration of the update waveform, or to be specific, the duration of the longest of the waveforms that may be applied.

Although this generates an excellent optical performance, it results in a relatively high power level, which is undesired.

Hence, an object of this invention is to achieve an electrophoretic display panel having a reduced power level in order to overcoming the above issues with the prior art, while still maintaining a good optical performance.

The above and other objects are at least in part achieved by an electrophoretic display panel by way of introduction, characterised in that said drive means, at least in a portion of the display, is arranged only update a first subgroup of pixels which, is arranged to display a greyscale in a current image frame which differs from the greyscale displayed in a previous image frame, and hence said drive means is arranged to intentionally avoid to update a second subgroup of pixels. Hence, by only addressing the subgroup of pixel for which the greyscale is changing, the remaining subgroup of pixels, for which the greyscale is not changing is not addressed. Thereby, the total power level for the display device may be decreased, since all pixels are not addressed during each image update. One example for which the present invention is applicable is for electronic book applications (for instance with black text on a white background), in which there is a considerable similarity between one image and a subsequent image. In fact, on average less than 20% of the pixels will actually change greyscale from one image to another, but in prior art displays all pixels are addressed during each image update. Hence, by not addressing the remaining 80% of the pixels in accordance with the invention, a considerable amount of power may be saved.

Suitably, the greyscale to be displayed by each of said pixels of said second subgroup of pixels is a most prevalent greyscale of the display panel. In this way, a large power saving is achieved. Preferably, the greyscale to be displayed by each of said pixels of said second subgroup of pixels is essentially white which for example is the case in e-book application.

The display panel further comprises an image information analyser arranged to analyse the image information for a current image frame to be displayed by the display panel with the image information of a previous image frame, the image information analyser being arranged to control said pixel drive means so as to, at least in a portion of the display, only update a subgroup of pixels which, as analysed by the image information analyser is arranged to display a greyscale in the current image frame which differs from the greyscale displayed in the previous image frame.

Suitably, the pixels are arranged in a matrix like fashion wherein the pixels are arranged along substantially straight addressing lines and along substantially straight data lines being substantially perpendicular to the addressing lines. Furthermore, passive or active matrix addressing may be used, and hence the present invention provides a flexible solution applicable to a diversity of electrophoretic display types.

According to a first embodiment of this invention, the update drive waveform is provided with a reset portion between each data portion, during which the display panel is not addressed. Preferably, during said reset portion all data lines are reset to a voltage of 0 V and by resetting all data columns to 0 V just after the addressing of an addressing line is completed and before the next line is addressed. Preferably, this is achieved by discharging the data line to ground using the data driver, which may be made without additional power dissipation. Hence, any pixel which is not to be addressed during a frame will therefore automatically be addressed at 0 V and will therefore not change its grey level. Consequently, display power for these pixels may be saved.

According to a second embodiment of this invention, said pixel drive means comprises a line addressing device, for commonly addressing an entire addressing line of pixels, wherein the image information analyser is arranged to control said pixel drive means so as to only address a subgroup of addressing lines which, as analysed by the image information analyser is arranged to display a greyscale in the current image frame which differs from the greyscale displayed in the previous image frame. Thereby, power may be saved, as the sub-group of lines which is not to be changed is not addressed. This embodiment is especially suitable for use in a paper-like display, such as an electronic book, on which rows of characters to form a text to be displayed are arranged to be displayed on a substantially constant background, since the addressing lines in the space between rows of characters are addressed very seldom. Suitably, the panel is also programmed to display said rows of characters in a letter font being designed to maximise the number of addressing lines between each rows of characters for which the greyscale to be displayed will be constant for subsequent image frames. For example, the height of letters with tails, such as j, y, q, p, and g may be minimised in order to increase the number of addressing lines between each row of characters that need not be addressed, and hence the power dissipation will be further reduced.

Suitably, said pixel drive means is connected with a look-up table, in which all possible update drive waveforms are stored, and also, said image information analyser is arranged to upload to said pixel drive means only the update drive waveforms for the pixels or data lines which are to be addressed during the current frame, thereby reducing both the system and display power dissipation.

This invention will hereinafter be described in closer detail by means of preferred embodiments thereof, with reference to the accompanying drawings.

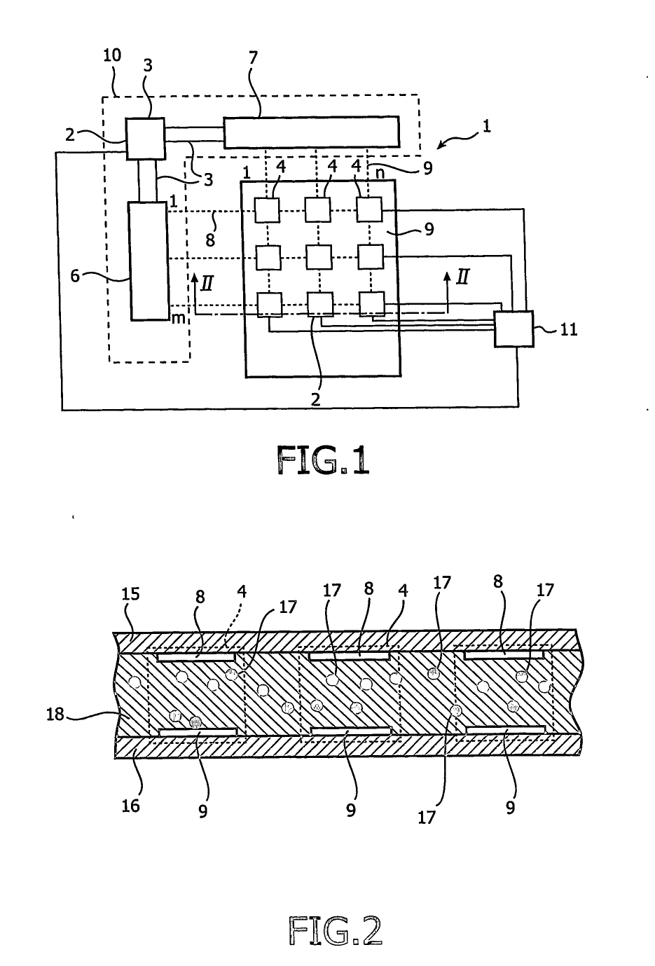

FIG. 1 is a schematic drawing of a display device according to this invention.

FIG. 2 is a cross-section taken along the line II-II in FIG. 1.

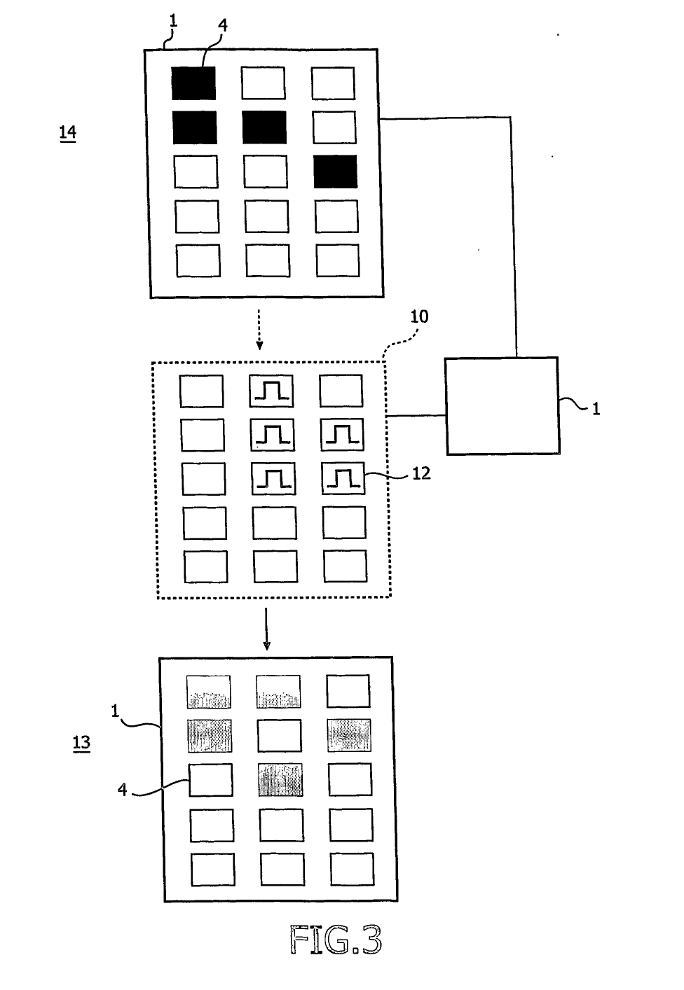

FIG. 3 is a schematic drawing of the display in FIG. 1, showing the sequence between two subsequent image frames according to one embodiment of this invention.

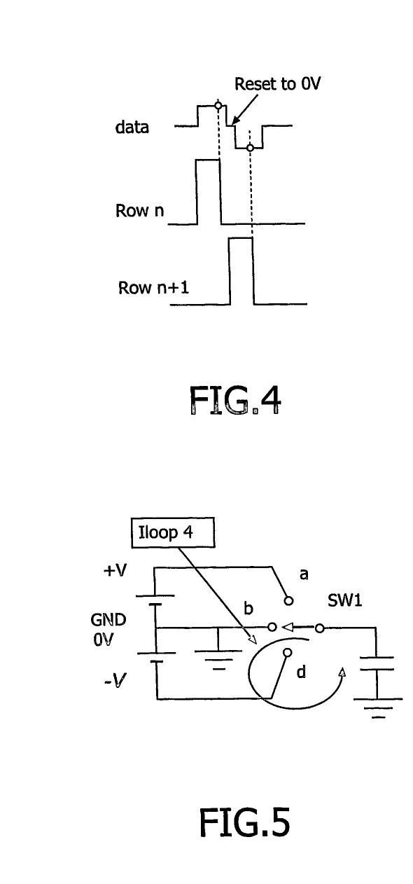

FIG. 4 discloses schematic drawing of a driving method according to a second embodiment of this invention.

FIG. 5 discloses a schematic drawing of a column driver circuit according to a third embodiment of this invention.

FIG. 1 shows an schematic drawing of a part of a display panel 1 to which the invention is applicable. It comprises a matrix of pixels 4, also referred to as picture elements, at the area of crossings of rows or addressing electrodes 8 and columns or data electrodes 9. The row electrodes 8 (1-m) are connected to a row driver 6 and the column electrodes 9 (1-n) are connected to a column driver 7. Both the row and column drivers are connected to a processor 3, to which an incoming image data signal 2 is arranged to be sent. Hence, an incoming image data signal arrives to the display device 1 via the processor 10, in which it may be processed before the respective drive signals is provided to the row and column drivers 6, 7. The row driver is arranged to consecutively select or address each of the row electrodes 1-m, while the column driver 7 is arranged to provide respective update drive waveform signals to each column 1-n. The relevant update drive waveform signals to be used in the display panel are suitably stored within a look-up table within the column driver 7. Mutual synchronisation between the row and column driver 6, 7 takes place via drive lines 5. Drive signals from the row driver 6 and the column driver 7 select a pixel 4. Together, the row and column drivers 6, 7 and the processor 3 is hence referred to as pixel drive means 10. In an active matrix embodiment, each pixel may further comprise switching electronics (not shown) comprising for example thin film resistors (TFTs), diodes or MIM devices.

As disclosed in FIG. 2, each pixel 4 essentially comprises a first and a second substrate 15, 16 of for example a glass or synthetic material, provided with a electrodes 8, 9, connected with pixel drive means 10 as described above. Between the substrates 15, 16 an amount of an electrophoretic medium is arranged, such as a light suspension fluid 18 containing dark, charged particles 17. By applying different potential differences over the electrodes 8, 9 and hence over the electrophoretic medium, the charged particles 17 are able to occupy a position being one of extreme positions near the electrodes and intermediate positions in between the electrodes for displaying a picture according to the incoming image data 2.

This invention is based on the realisation that, in a display where all pixels are individually connected, such as a segmented display, or a display on top of a silicon CMOS integrated circuit, it is possible to only address the pixels which are to change grey level from one frame to the next, thereby reducing the power consumption of the display. Alternatively, in a matrix display, such as active or passive matrix displays, in which one row at a time is addressed, it is possible to only address the rows in which all pixels are to change grey level from one frame to the next, thereby reducing the power consumption of the display.

According to this invention (see FIG. 3), the display panel further comprises an image information analyser 11, which is arranged to control said pixel drive means 10 so as to only update, at least in a portion of the display, a subgroup of pixels 4 which, as analysed by the image information analyser 11 is arranged to display a greyscale in the current image frame 13 which differs from the greyscale displayed in the previous image frame 14. Suitably, the above is utilised for the entire display, and not only for a portion of it. This may be done either by only addressing a subgroup of all rows 8 or by only provide update waveforms to a subgroup of columns 9. Hence, as indicated in FIG. 3, the present greyscale of each pixel 4 in a displayed (first) frame 14 is detected and these greyscales are thereafter compared with the greyscales of the next (second) frame 13 to be displayed. This comparison may for example be done in said processor 3. The processor is thereafter programmed to send out drive signals (i.e. address the suitable rows and columns) only for those pixels whose greyscale differs between the two frames. In FIG. 3, for example, no update waveforms need to be provided to the left hand column.

The detection of the greyscales of the first frame 13 may either be done by actually detecting the greyscale of each pixel by means of a detector (not shown) and sending this information to the pixel drive means 10, or by storing greyscale information for each pixel of each frame in a dedicated memory (not shown) within the pixel drive means, whereafter it may be used for comparison with the next frame that is sent to the pixel drive means, whereafter the stored information is replaced with new information regarding the greyscales of the next frame.

A first embodiment of this invention will hereinafter be described in closer detail with reference to FIG. 1 and is especially suitable for e-book applications. In this embodiment, power savings are realised by avoiding update of all rows where the grey level of all pixels in the row are unchanged from one image frame to the next. Hence, the subgroup of rows that is to be addressed is the rows in which at least one pixel is to change its greyscale in the next frame. In the e-book example, there will be a plurality of rows in-between lines of text (constituting the spacing between the lines) that always is to display “white”, and according to the invention these rows will not be addressed, whereby power may be saved. On a standard text page, the spacings may represent 30-50% of the total display area, and since the display power dissipation is directly related to the number of lines addressed, the power saving in this example will also be around 30-50%. Preferably, the display is programmed to use letter fonts which are compact and hence maximise the spacing between lines of text, for example by minimising the height of letters having tails, such as j, y, q, p, and g. This approach will further increase the number of rows that need not bee addressed, i.e. the power dissipation will be further reduced.

Moreover, in the embodiment described above, it is possible to also reduce the system power, by avoiding to load update drive waveforms from the look-up table for the pixels in rows that is not to be addressed. This results in a lower data rate, which in turn results in either a reduction of system power, or allow an increase in system speed (i.e. faster image update) or both. A faster image update opens up the possibility to generate a larger number of more accurate grey levels in an electrophoretic display.

A second embodiment of this invention will hereinafter be described in closer detail with reference to FIG. 4 and FIG. 5. Here, a more general approach is suggested, in which it is possible to avoid addressing pixels also in rows in which not all pixels in the row have an unchanged grey level from one frame to the next. This approach is for example useable in matrix displays, such as active or passive matrix displays, in which one row at a time is addressed, and hence only entire rows may be left out in addressing. According to this embodiment, all data columns 1-n are resetted to 0 V, just after the addressing of a line is completed and before the next line is addressed, i.e. each data portion of the update drive waveform is separated by a reset portion. This is illustrated in FIG. 4. Preferably, this reset portion is realised by discharging the line to ground potential between each data portion. An example of such a circuit is disclosed in FIG. 5. This approach is advantageous in that said discharge may be carried out without further power dissipation. Due to this action, any pixel that is not to be addressed, will be automatically addressed at 0 V, and will therefore not change its grey level, as required. Moreover, it is not necessary to upload drive waveforms for such pixels into the column driver itself, i.e. it is not necessary to send any data to the column drivers for rows that is not to be addressed. Hence, both display and system power will be saved for these pixels.

It shall also be noted that the present invention is equally applicable to monochrome and colour displays, and hence the term “greyscale” as used herein shall be construed as a tone or colour intensity that is to be displayed by a pixel during a specific time frame.

Also, it shall be noted that the above described embodiments describe situations where only the most prevalent type of pixels, which do not change greyscale from one image to another, are not addressed (for example the white pixels for a text page), more generally, the subset of those pixels which do not change grey scale form one image to another could also include pixels of more than one greyscale.

Further, it shall be noted that the protective scope of the invention is not limited to the embodiments described. Moreover, any combination of the embodiments described above is alternatively applicable.

1. An electrophoretic display panel (1), for displaying an image corresponding to image information, comprising:
a plurality of pixels (4), each containing an amount of an electrophoretic material,
an electrode arrangement (8,9) associated with each pixel (4) for receiving a potential difference as defined by an update drive waveform (12); and
pixel drive means (10), for controlling said update drive waveform (12) of each pixel (4); characterized in that said drive means (10), at least in a portion of the display, is arranged to update a first subgroup of pixels (4) which, is arranged to display a greyscale in a current image frame (13) which differs from the greyscale displayed in a previous image frame (14), and hence said drive means is arranged to intentionally avoid to update a second subgroup of pixels (4).

2. An electrophoretic display panel as in claim 1, wherein the greyscale to be displayed by each of said pixels (4) of said second subgroup of pixels (4) is most prevalent greyscale of the display panel.

3. An electrophoretic display panel as in claim 1, wherein the greyscale to be displayed by each of said pixels (4) of said second subgroup of pixels (4) is essentially white.

4. An eletrophoretic display panel as in claim 1, wherein the display panel further comprises an image information analyser (11) arranged to analyse the image information for a current image frame (13) to be displayed by the display panel with the image information of a previous image frame (14), the image information analyser (11) being arranged to control said pixel drive means (10) so as to, at least in a portion of the display, only update a subgroup of pixels (4) which, as analysed by image information analyser (11) is arranged to display a greyscale in the current image frame (13) which differs from the greyscale displayed in the previous image frame (14).

5. An electrophoretic display panel as in claim 1, wherein the pixels (4) is arranged in a matrix like fashion wherein the pixels are arranged along substantially straight addressing lines and along substantially straight data lines being substantially perpendicular to the addressing lines.

6. An electrophoretic display panel as in claim 1, wherein the update drive waveform (12) is provided with reset portion between each data portion, during which the display panel is not addressed.

7. An electrophoretic display panel as in claim 6, wherein, during said reset portion all data lines are reset to a voltage of 0 V.

8. An electrophoretic display panel as in claim 5, wherein said pixel drive means (10) comprises a line addressing device, for commonly addressing an entire addressing line of pixels, wherein the image information analyser (11) is arranged to control said pixel drive means (10) so as to only address (12) a subgroup of addressing lines comprising a pixel which, as anlalysed by the image information analyser (11) is arranged to display a greyscale in the current image frame (13) which differs form the greyscale displayed in the previous image frame (14).

9. An electrophoretic display panel as in claim 1 for use in a paper-like display, such as an electronic book, on which rows of characters to forma a text to be displayed are arranged to be displayed on a substantially constant background.

10. An electrophoretic display panel as in claim 9, wherein the panel is programmed to display said rows of characters in a letter font being designed to maximise the number of addressing lines between each rows of characters for which the greyscale to be displayed will be constant for subsequent image frames.

11. An eletrophoretic display panel as in claim 1, wherein said pixel drive means (10) is connected with a look-up table, in which all possible update drive waveforms are stored.

12. An electrophoretic display panel as in claim 11, wherein said image information analyser (11) is arranged to upload to said pixel drive means (10) only the update drive waveforms for the pixels of data lines which are to be addressed during the current frame.
